(19) United States
(12) Patent Application Publication
(10) Pub. No.: US 2024/0362107 A1
(43) Pub. Date: Oct. 31, 2024

(54) METHOD AND SYSTEM FOR PROCESSING ERROR LOGS

(71) Applicant: JPMorgan Chase Bank, N.A., New York, NY (US)

(72) Inventors: Soumya JAIN, Sagar (IN); Jatin Ramesh GALIA, Mumbai (IN); Abhishek RUNWAL, Jaipur (IN)

(73) Assignee: JPMorgan Chase Bank, N.A., New York, NY (US)

(21) Appl. No.: 18/643,402

(22) Filed: Apr. 23, 2024

(30) Foreign Application Priority Data
Apr. 26, 2023 (IN) 20231103103

(51) Int. Cl. G06F 11/07; G06F 11/34

(52) U.S. Cl. CPC G06F 11/079; G06F 11/0787; G06F 11/3476

(57) ABSTRACT

A method and system for processing error logs are disclosed. The method includes receiving a plurality of logs generated during a runtime of at least one application. The method includes analyzing the plurality of logs to determine an occurrence of at least one error log in the plurality of logs based upon predefined criteria. The method includes storing the at least one error log based on the analysis of the plurality of logs, into an error log table, at least one database and a topic. Next, the method includes replaying the at least one error log in accordance with predefined execution criteria to execute the corresponding error log from a point of failure in the at least one application. Next, the method includes removing the replayed at least one error log upon a successful execution in the at least one application, from the at least one topic.

### CROSS-REFERENCE TO RELATED APPLICATIONS

This application claims priority benefit from Indian application Ser. No. 20/231,1030103, filed on Apr. 26, 2023 in the India Patent Office, which is hereby incorporated by reference in its entirety.

### FIELD OF THE DISCLOSURE

This technology generally relates to monitoring error logs, and more particularly relates to methods and systems for processing and resolving error logs within the data processing systems.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

With advancements in technology, various sectors are accelerating their operations through the utilization of various tools and software. The use of such tools and software generates plurality of logs which includes data associated with various events such as login attempts, payment transactions, etc. The generated plurality of logs is often required to be monitored and processed in real time as any inconsistency observed in the logs may create a huge impact on operation and functioning of the application. The inconsistency in the logs may be due to various unavoidable events such as abrupt termination of services, network issues, loss of path etc.

Some of the existing applications utilize a microservice architecture to store and process such error logs. Though the microservice architecture offers great feasibility in management and tracing of logs, it also creates multiple points for loss of error logs throughout the processing. Additionally, message queues of the microservice architecture offer functionality to capture and process the error logs during unavoidable events. However, the message queues fail to reprocess such large amount of data or error logs to recover error records. The lack of reprocessing creates issues when the applications are supposed to receive related information in different fractions at different intervals of time. Also, the existing microservice architecture fails to handle the error logs during the unavoidable events which put adverse effect on functionalities of the application.

Hence, in view of these and other existing limitations, there arises an imperative need to provide an efficient solution to overcome the above-mentioned limitations and to provide a method and system that can be integrated into any microservice architecture to process error records for ensuring a plug-and-play self-healing solution to the existing applications.

### SUMMARY

The present disclosure, through one or more of its various aspects, embodiments, and/or specific features or sub-components, provides, inter alia, various systems, servers, devices, methods, media, programs, and platforms for processing error logs.

According to an aspect of the present disclosure, a method for processing error logs is disclosed. The method is implemented by at least one processor. The method includes receiving, by the at least one processor, a plurality of logs generated during a runtime of at least one application. Next, the method includes analyzing, by the at least one processor, the plurality of logs to determine an occurrence of at least one error log in the plurality of logs based upon predefined criteria. Next, the method includes storing, by the at least one processor, the at least one error log based on the analysis of the plurality of logs, into an error log table, at least one database and at least one topic. Next, the method includes replaying, by the at least one processor, the at least one error log in accordance with predefined execution criteria. The replay of the at least one error log is performed to execute the at least one error log from a point of failure of the corresponding at least one error log in the at least one application. Next, the method includes removing, by the at least one processor, the replayed at least one error log upon a successful execution of the at least one error log in the at least one application, from the at least one topic.

In accordance with an exemplary embodiment, the method further includes marking, by the at least one processor, the at least one error log as processed in the at least one database upon the successful execution of the replayed at least one error log.

In accordance with an exemplary embodiment, upon a failure of execution of the at least one error log, the method further includes updating, by the at least one processor, a plurality of parameters for the replayed at least one error log in case of an occurrence of a failure caused to the replayed at least one error log. The plurality of parameters includes a retry count and a retry interval for the failed at least one error log. Next, the method further includes repeating, by the at least one processor, the replay of the at least one failed error log according to the predefined execution criteria in the at least one application after updating the plurality of parameters for the replayed at least one error log.

In accordance with an exemplary embodiment, the plurality of logs includes a set of data associated with a plurality of records and events generated during the runtime of the at least one application.

In accordance with an exemplary embodiment, the error log table includes an error date, a service text, an error type, a record identification, a send timestamp, an error message, a payload, a retry count, a retry status, a source, and a primary key.

In accordance with an exemplary embodiment, the predefined criteria correspond to validating that a type of parameter corresponds to a source record, checking a presence of the at least one error log in a list of exception classes, and checking whether the at least one error log falls in the list of the exception classes for which error logging has to be skipped.

In accordance with an exemplary embodiment, the at least one topic includes error messages generated by the at least one error log.

In accordance with an exemplary embodiment, the predefined execution criteria include a threshold number of retries and a configured retry interval for the at least one error log.

In accordance with an exemplary embodiment, the method includes replaying, by the at least one processor, the at least one error log stored in the at least one database upon receiving a replay request from at least one user.

According to another aspect of the present disclosure, a computing device configured to implement an execution of a method for processing error logs is disclosed. The computing device includes a processor; a memory; and a communication interface coupled to each of the processor and the memory. The processor may be configured to receive a plurality of logs generated through a runtime of at least one application. Next, the processor may be configured to analyze the plurality of logs to determine an occurrence of at least one error log in the plurality of logs based upon predefined criteria. Next, the processor may be configured to store the at least one error log based on the analysis of the plurality of logs, into an error log table, at least one database and at least one topic. Next, the processor may be configured to replay the at least one error log in accordance with predefined execution criteria. The replay of the at least one error log is performed to execute the at least one error log from a point of failure of the corresponding at least one error log in the at least one application. Next, the processor may be configured to remove the replayed at least one error log upon a successful execution of the at least one error log in the at least one application, from the at least one topic.

In accordance with an exemplary embodiment, the processor may be further configured to mark the at least one error log as processed in the at least one database upon the successful execution of the replayed at least one error log.

In accordance with an exemplary embodiment, the processor may be further configured to update a plurality of parameters for the replayed at least one error log in case of an occurrence of a failure caused to the replayed at least one error log. The plurality of parameters includes a retry count and a retry interval for the failed at least one error log. Next, the processor may be further configured to repeat the replay of the at least one failed error log in accordance with the predefined execution criteria in the at least one application after updating the plurality of parameters for the replayed at least one error log.

In accordance with an exemplary embodiment, the plurality of logs includes a set of data associated with a plurality of records and events generated during the runtime of the at least one application.

In accordance with an exemplary embodiment, the error log table includes an error date, a service text, an error type, a record identification, a send timestamp, an error message, a payload, a retry count, a retry status, a source, and a primary key.

In accordance with an exemplary embodiment, the predefined criteria correspond to validating that a type of parameter corresponds to a source record, checking a presence of the at least one error log in a list of exception classes, and checking whether the at least one error log falls in the list of the exception classes for which error logging has to be skipped.

In accordance with an exemplary embodiment, the at least one topic includes error messages generated by the at least one error log.

In accordance with an exemplary embodiment, the predefined execution criteria include a threshold number of retries and a configured retry interval for the at least one error log.

In accordance with an exemplary embodiment, the processor may be configured to replay the at least one error log stored in the at least one database upon reception of a replay request from at least one user.

According to yet another aspect of the present disclosure, a non-transitory computer-readable storage medium storing instructions for processing error logs is disclosed. The instructions include executable code which, when executed by a processor, may cause the processor to receive a plurality of logs generated through a runtime of at least one application; analyze the plurality of logs to determine an occurrence of at least one error log in the plurality of logs based upon predefined criteria; store the at least one error log based on the analysis of the plurality of logs, into an error log table, at least one database and at least one topic; replay the at least one error log in accordance with a predefined execution criteria, wherein the replay of the at least one error log is performed to execute the at least one error log from a point of failure of the corresponding at least one error log in the at least one application; and remove the replayed at least one error log upon a successful execution of the at least one error log in the at least one application, from the at least one topic.

In accordance with an exemplary embodiment, the executable code, when executed, further causes the processor to mark the at least one error log as processed in the at least one database upon the successful execution of the replayed at least one error log.

In accordance with an exemplary embodiment, the executable code, when executed, further causes the processor to update a plurality of parameters for the replayed at least one error log in case of an occurrence of a failure caused to the replayed at least one error log. The plurality of parameters includes a retry count and a retry interval for the failed at least one error log. Next, the executable code, when executed, further causes the processor to repeat the replay of the at least one failed error log in accordance with the predefined execution criteria in the at least one application after updating the plurality of parameters for the replayed at least one error log.

In accordance with an exemplary embodiment, the plurality of logs includes a set of data associated with a plurality of records and events generated during the runtime of the at least one application.

In accordance with an exemplary embodiment, the error log table includes an error date, a service text, an error type, a record identification, a send timestamp, an error message, a payload, a retry count, a retry status, a source, and a primary key.

In accordance with an exemplary embodiment, the predefined criteria correspond to validating that a type of parameter corresponds to a source record, checking a presence of the at least one error log in a list of exception classes, and checking whether the at least one error log falls in the list of the exception classes for which error logging has to be skipped.

In accordance with an exemplary embodiment, the at least one topic includes error messages generated by the determined at least one error log.

In accordance with an exemplary embodiment, the predefined execution criteria include a threshold number of retries and a configured retry interval for the at least one error log.

### BRIEF DESCRIPTION OF THE DRAWINGS

The present disclosure is further described in the detailed description which follows, about the noted plurality of drawings, by way of non-limiting examples of exemplary embodiments of the present disclosure, in which like characters represent like elements throughout the several views of the drawings.

FIG. 1 illustrates an exemplary computer system for processing error logs, in accordance with an exemplary embodiment of the present disclosure.

FIG. 2 illustrates an exemplary diagram of a network environment for processing error logs, in accordance with an exemplary embodiment of the present disclosure.

FIG. 3 illustrates an exemplary system for processing error logs, in accordance with an exemplary embodiment of the present disclosure.

FIG. 4 illustrates an exemplary method flow diagram for processing error logs, in accordance with an exemplary embodiment of the present disclosure.

FIG. 5A and FIG. 5B illustrate a process flow diagram usable for processing error logs, in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as at least one non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

To overcome the above-mentioned problems, the present disclosure provides a method and system for processing error logs. More particularly, various applications or software often face problems such as abrupt termination of services, network issues, database failure, etc. due to occurrence of errors in the log files associated with applications or software. The present disclosure provides a plug-and-play solution that enables capturing of error logs generated due to such unavoidable events and replays the error logs to reprocess error logs in the data processing applications to avoid failure functioning of the applications. In the present disclosure, at first, the system receives a plurality of logs generated through a runtime of at least one application. Further, the system determines error logs from the plurality of logs and stores the determined error logs in an error table, a database, and a topic. The system further replays the at least one error log from the plurality of error logs in accordance with predefined execution criteria to execute the at least one error log from a point of failure of the corresponding at least one error log in the at least one application. The system further removes the replayed at least one error log upon successful execution of the at least one error log in the at least one application, from the at least one topic. This way, the system performs processing of error logs, which in turn helps in providing self-healing to the data processing services.

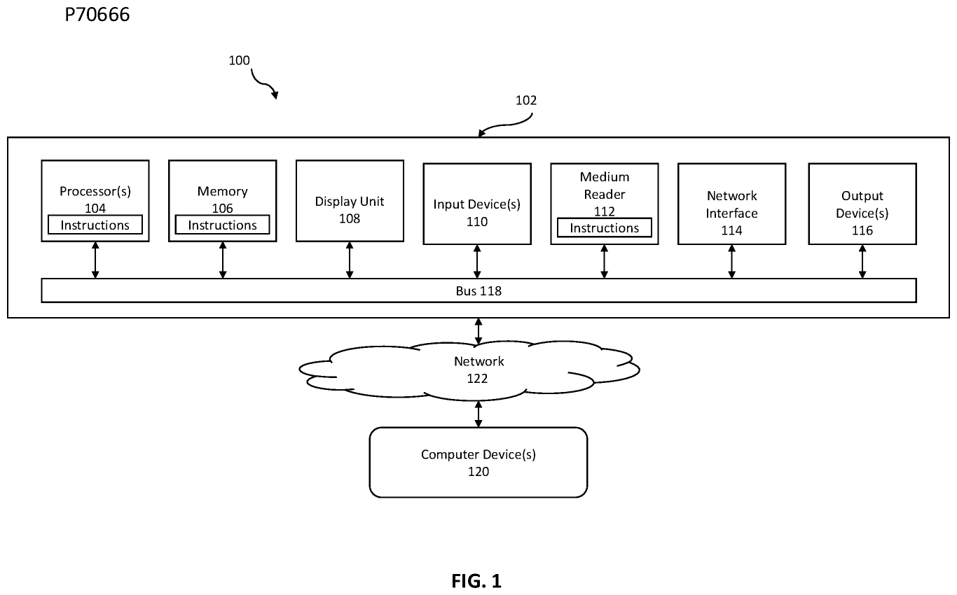

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environments. Even further, the instructions may be operative in such a cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems for processing error logs.

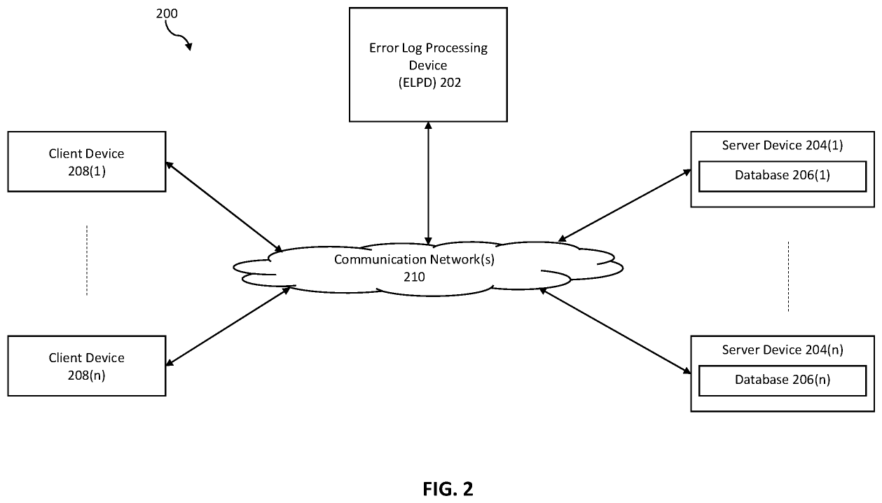

Referring to FIG. 2, a schematic of an exemplary network environment 200 for processing error logs is illustrated. In an exemplary embodiment, the method is executable on any networked computer platform, such as, for example, a personal computer (PC).

The method for processing error logs may be executed by an error log processing device (ELPD) 202. The ELPD 202 may be the same or similar to the computer system 102 as described with respect to FIG. 1. The ELPD 202 may store one or more applications that may include executable instructions that, when executed by the ELPD 202, cause the ELPD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the ELPD 202 itself, may be located in the virtual server(s) running in a cloud-based computing environment rather than being tied to one or more specific physical network computing devices. Also, the application(s) may be running in one or more virtual machines (VMs) executing on the ELPD 202. Additionally, in one or more embodiments of this technology, virtual machine(s) running on the ELPD 202 may be managed or supervised by a hypervisor.

In the network environment 200 of FIG. 2, the ELPD 202 is coupled to a plurality of server devices 204(1)-204(n) that hosts a plurality of databases 206(1)-206(n), and also to a plurality of client devices 208(1)-208(n) via communication network(s) 210. A communication interface of the ELPD 202, such as the network interface 114 of the computer system 102 of FIG. 1, operatively couples and communicates between the ELPD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ELPD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and ELPDs that efficiently implement the method for processing error logs.

By way of example only, the communication network(s) 210 may include local area network(s) (LAN(s)) or wide area network(s) (WAN(s)), and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The ELPD 202 may be a standalone device or integrated with one or more other devices or apparatuses, such as one or more of the server devices 204(1)-204(n), for example. In one particular example, the ELPD 202 may include or be hosted by one of the server devices 204(1)-204(n), and other arrangements are also possible. Moreover, one or more of the devices of the ELPD 202 may be in a same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the ELPD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data related to a plurality of logs received from at least one application, an error log table.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ELPD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the ELPD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the ELPD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ELPD 202, the server devices 204(1)-204(n), or the client devices 208(1)-208(n), for example, may be configured to operate as virtual instances on the same physical machine. In other words, one or more of the ELPD 202, the server devices 204(1)-204(n), or the client devices 208(1)-208(n) may operate on the same physical device rather than as separate devices communicating through communication network(s) 210. Additionally, there may be more or fewer ELPDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

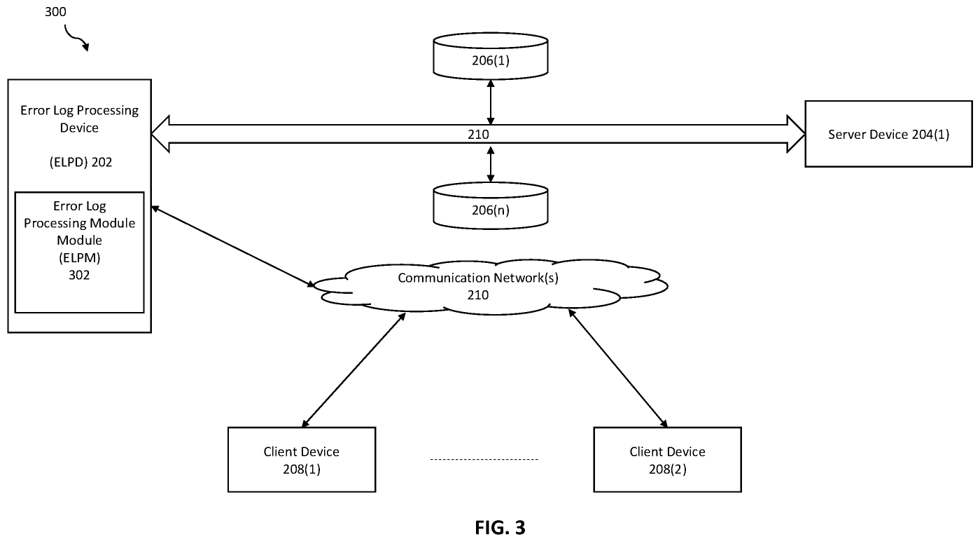

FIG. 3 illustrates an exemplary system for processing error logs, in accordance with an exemplary embodiment. As illustrated in FIG. 3, according to exemplary embodiments, the system 300 may comprise an error log processing device (ELPD) 202 including an error log processing module (ELPM) 302 that may be connected to a server device 204(1) and one or more repository from the repositories 206(1) . . . 206(n) via a communication network 210, but the disclosure is not limited thereto.

The ELPD 202 is described and shown in FIG. 3 includes the ELPM 302, although it may include other rules, policies, modules, databases, or applications, for example. As will be described below, the ELPM 302 is configured to carry out a method for processing error logs.

An exemplary system 300 for enabling a mechanism for processing error logs by utilizing the network environment of FIG. 2 is shown as being executed in FIG. 3. Specifically, a first client device 208(1) and a second client device 208(2) are illustrated as being in communication with the ELPD 202. In this regard, the first client device 208(1) and the second client device 208(2) may be “clients” of the ELPD 202 and are described herein as such. Nevertheless, it is to be known and understood that the first client device 208(1) and/or the second client device 208(2) need not necessarily be “clients” of the ELPD 202, or any entity described in association therewith herein. Any additional or alternative relationship may exist between either or both of the first client device 208(1) and the second client device 208(2) and the ELPD 202, or no relationship may exist.

Further, the ELPD 202 is illustrated as being able to access one or more repositories 206(1) . . . 206(n). The ELPM 302 may be configured to access these repositories/databases to provide a method for processing error logs.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the ELPD 202 via broadband or cellular communication. These embodiments are merely exemplary and are not limiting or exhaustive.

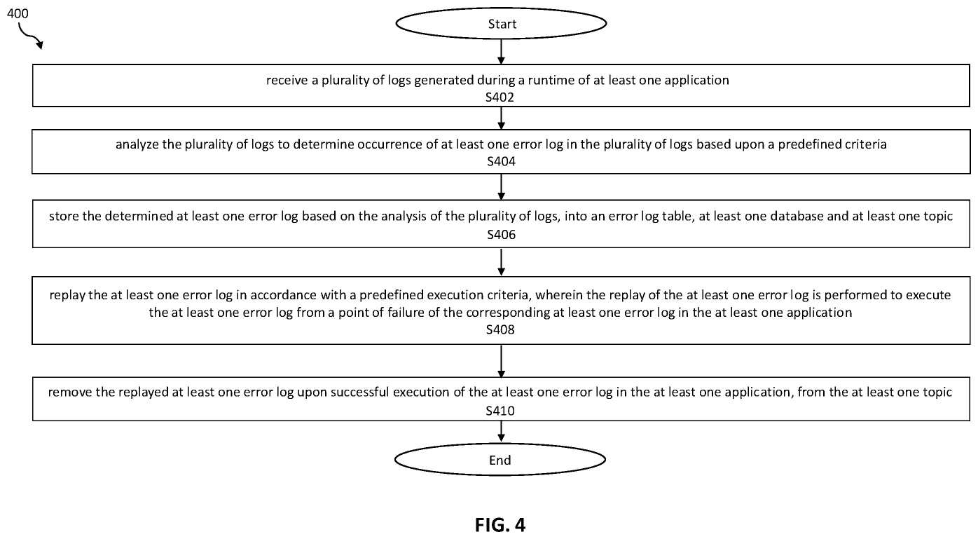

Referring to FIG. 4, an exemplary method 400 is shown for processing error logs, in accordance with an exemplary embodiment. In particular, the exemplary method 400 is shown for processing error logs to provide a self-healing service for data processing applications or services.

As shown in FIG. 4, method 400 begins following a need for processing of error logs and replaying of the error logs to provide a plug-and-play self-healing solution to the data processing applications or services. The method 400 is implemented by at least one processor 104.

At step S402, the method 400 includes receiving, by the at least one processor 104, a plurality of logs generated during a runtime of at least one application.

The term “logs” herein may correspond to files which contain information about events that have occurred within an application. The logs may include errors, warnings, or information about events.

The term “application” herein may correspond to a software program or tool that is designed to perform specific tasks or functions for the user. The term “data processing applications” herein may correspond to a software program or system that is designed to manipulate, process, and analyze data to produce meaningful information.

The term “runtime” herein may correspond to a period during which a program or application is running and executing commands on a computer or device.

The plurality of logs includes a set of data associated with a plurality of records and events generated during the runtime of the at least one application.

For example, a server or a database stores the plurality of logs generated during the run time of applications. In one exemplary implementation, the method includes fetching, by the at least one processor 104, the plurality of logs associated with the at least one application from at least one external source. The at least one external source may be selected from, but not limited to, a server, a cloud server, at least one database, network-attached storage solid state drive (SSD), or other memory storage means. The at least one database is connected with the at least one processor 104 via a network. The network may be an Internet based network.

In one exemplary implementation, the plurality of logs may be fetched using secure data communication protocols to ensure the integrity and confidentiality of the plurality of logs. It would be appreciated by the person skilled in the art that the aim here is to create a centralized error logging and replay library that automatically processes and replays error logs into the at least one application to provide self-healing to the at least one application.

At step S404, the method includes analyzing, by the at least one processor 104, the plurality of logs to determine the occurrence of at least one error log in the plurality of logs based upon predefined criteria.

The term “error log” herein may correspond to a file that records information about errors and other important events that occur during the operation of a software application or system.

In one implementation, the predefined criteria correspond to validating that a type of parameter corresponds to a source record, checking a presence of the at least one error log in a list of exception classes (or a list of exception classes for which an error has to be recorded), and checking whether the at least one error log falls in a list of the exception classes for which error logging has to be skipped (or a list of exception classes for which logging has to be skipped).

For example, in the context of message processing, if an inbound transaction fails due to certain unchecked exceptions (e.g., Null Pointer) or service exceptions e.g., “connection Timeout/hypertext transfer protocol (HTTP) status code 50x” to certain application programming interface (API)/method, then an inbound transaction message will be recorded as an error log for retry or self-healing.

For example, in the context of message processing, if an inbound transaction is marked as processed but considered failed due to missing mandatory contract, e.g., a field correlation_ID is needed, but missing in an inbound transaction message, then the application will mark the inbound transaction message as a failure and choose to not reprocess the inbound transaction message, hence skip the self-healing.

The method includes determining, by the at least one processor 104, the at least one error log upon satisfying the criteria of validating the type of parameter that corresponds to the original record or source record. The method further excludes any other exception that occurred outside the list of exception classes (for example, child classes are also covered in the list of expectation classes). The at least one processor 104 determines the at least one error log, if an error occurs within the list of exception classes for which the error has to be recorded.

At step S406, the method includes storing, by the at least one processor 104, the determined at least one error log based on the analysis of the plurality of logs, into an error log table, at least one database, and at least one topic.

The term “error log table” herein may correspond to a database table specifically designed to store information about errors that occur within an application or system.

The term “topic” herein may correspond to the specific aspect or category of errors (for example, application errors, system errors, network errors, database errors, etc.) that are being logged and monitored.

For example, the topic is a staging area in asynchronous processing, presented as a queue for error messages to be persisted for future replay during self-heal or self-resolution. Further, the topic is parallel to the error log table. The purpose is to provide replay capabilities by listening to the topic for events availability and replay (e.g., self-heal).

The at least one topic includes error messages generated by the determined at least one error log. The error log table includes error date, service text, error type, record identification (also referred to herein as “record id”), send timestamp, error message, payload, retry count, retry status, source, and primary key. The error log table may provide manual triggering capabilities, audit, and analytics.

The term “error date” refers to a date on which failure of the at least one error log has occurred. The term “service text” refers to a text indicating the originating service of the at least one error log. The term “record id” refers to a unique identifier associated with the at least one error log. The term “send timestamp” refers to an identifier to indicate the time when the at least one error log was generated. The term “error message” refers to a cause of the error (or cause of failure) or its stack trace may be stored. The term “retry count” refers to the number of times a particular error log has to be retried or replayed. The term “retry status” refers to the status of the final retry (for example, indicating a successful or failed retry). The term “source” refers to a source associated with the individual error log.

In one exemplary implementation, the at least one application (or onboarding applications services) must serialize the original message and store it in the error log table as a part of the payload. When self-healing is triggered then the same original message gets processed from the error log table.

In one exemplary implementation, the method further includes storing, by the at least one processor 104, the plurality of error logs that are determined as error logs into the at least one database for allowing at least one user to perform manual reprocessing or execution of the plurality of error logs (or also referred as at least one error log). For example, a user may select error logs from the plurality of error logs stored in the at least one database to manually process the error logs. The plurality of error logs may first stored in the at least one database and then error logs may be selected by the user for processing.

In one exemplary implementation, the method includes fetching, by the at least one processor 104, the plurality of error logs from at least one external source (or at least one application). The at least one external source may be selected from but not limited to, a server, a cloud server, the at least one database, or a data processing service. The data processing service is connected with the at least one processor 104 via a network. The network may be an Internet based network. In one exemplary implementation, the plurality of error logs may be fetched using secure data communication protocols to ensure the integrity and confidentiality of the plurality of error logs.

At step S408, the method includes replaying, by the at least one processor 104, the at least one error log in accordance with predefined execution criteria. The replay of the at least one error log is performed to execute the at least one error log from a point of failure of the corresponding at least one error log in the at least one application.

The term “point of failure” herein may correspond to the specific instance at which an error or issue occurs, leading to a failure in at least one functionality of the application.

The term “replaying” refers to the act of executing or re-running the data or actions that led to an error in the application based on the information recorded in error logs.

The predefined execution criteria include a threshold number of retries (for example, if the number of retries is set as 3 then an error log may be replayed three times) and a configured retry interval for the at least one error log. The at least one processor 104 causes to replay the at least one error in the at least one application to resolve the determined at least one error based on the predefined execution criteria. The configured retry interval may selected from but not limited to, seconds, minutes, hours, and days. Following the predefined execution criteria, the at least one processor 104 causes to replay the at least one error log for the threshold number of retries or configured retry interval to execute the at least one error log. If the at least one error is failed to be executed in the predefined execution criteria then an update in the predefined execution criteria will be performed by the at least one processor 104 and again replay of the at least one error log will be repeated by the at least one processor 104. The update in the predefined execution criteria may correspond to updating parameters such as an increase/decrease in a number of retries or retry interval.

At step S410, the method includes removing (or also referred as deleting), by the at least one processor 104, the replayed at least one error log upon successful execution of the at least one error log in the at least one application, from the at least one topic. For example, if the at least one error log is successfully executed as per the predefined execution criteria then that at least one processor deletes the at least one error log from the at least one topic.

The method further includes updating, by the at least one processor 104, the at least one topic after successful execution of the replayed at least one error log. This way the present disclosure performs processing of error logs and provides a plug and play self-healing solution for the at least one application without requiring massive code changes to resolve the error logs.

The method further includes marking, by the at least one processor 104, the at least one error log as processed in the at least one database upon the successful execution of the replayed at least one error log. The successful execution of the replayed at least one error log resolves an issue related to the at least one error log in the at least one application. The at least one database maintains an updated record of the error log table after every successful execution of the at least one error log.

The method further includes updating, by the at least one processor 104, a plurality of parameters for the replayed at least one error log in case of occurrence of failure caused to the replayed at least one error log. The plurality of parameters includes the retry count and retry interval for the failed at least one error log. For example, the update of the plurality of parameters may correspond to the increase/decrease of retry count and retry interval for the failed at least one error log.

The method further includes repeating, by the at least one processor 104, replay of the at least one failed error log according to the predefined execution criteria after updating the plurality of parameters for the replayed at least one error log and in case of the failure of the at least one error that replayed in the at least one application.

For example, if an error log fails to be processed during a first replay into an application, then the failed error log is again replayed in the application by the at least one processor 104 in accordance with the predefined execution criteria (for example, number of retries are 5 and retry interval is 3 minutes) to process the error log in the application. The retry interval may be selected from but not limited to, seconds, minutes, hours, and days.

In one implementation, the method includes replaying, by the at least one processor 104, the at least one error log stored in the at least one database upon receiving a replay request from at least one user. The number of retries may be provided by the at least one user in case of a manual replay request.

In one exemplary implementation, the method includes generating, by the at least one processor 104, a detailed failure message in the event of unsuccessful execution of the at least one error log. In one implementation, the at least one processor 104 may transmit a notification (over a user interface (UI) of a platform) to the at least one user upon failure of execution of the replayed at least one error log. In one implementation, the notification may be customized to be delivered via various channels, such as email, SMS, or even as a push notification from an application, depending on the system's capabilities.

The method further includes receiving, by the at least one processor 104, the replay request from the at least one user over a user interface (UI) of a platform in order to allow the at least one user to perform manual processing of the at least one error log that stored in the at least one database. The at least one user may raise the replay request using the UI of the platform that is connected to the at least one database.

In one exemplary implementation, the method includes purging, by the at least one processor 104, the at least one error log that was successfully executed, from the error log table. For example, the at least one processor 104 may keep failed records (e.g., at least one error log) for a predefined time period days (e.g., few days) for audit and then purge the at least one error log.

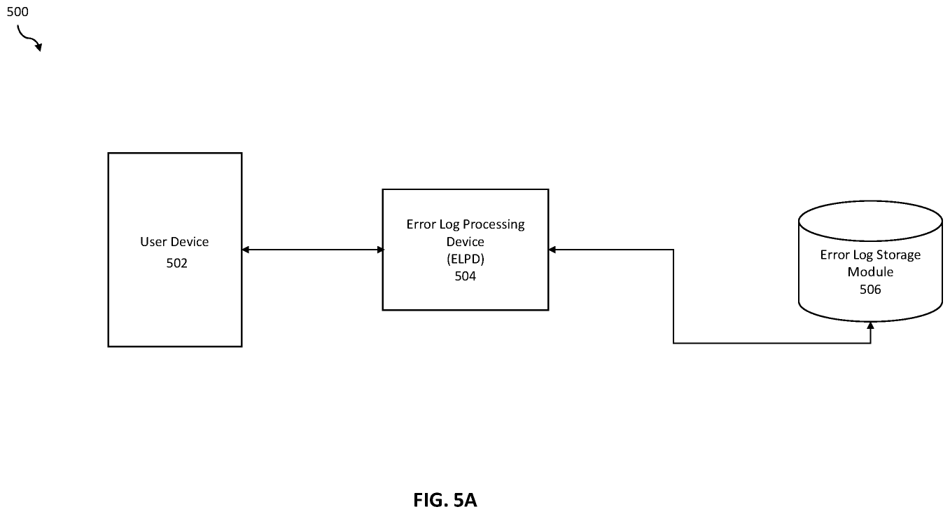

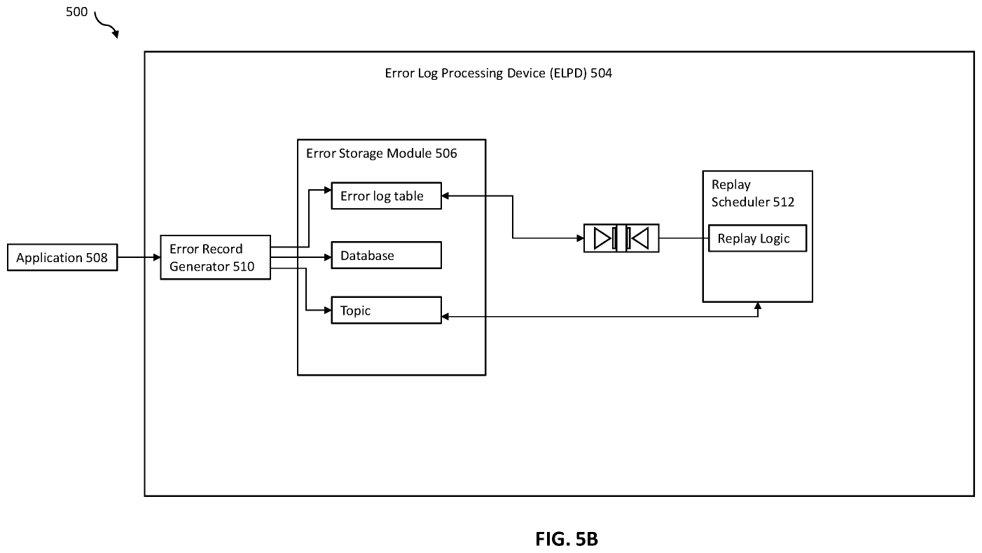

FIGS. 5A and 5B illustrate a process flow diagram that represents a method for processing error logs, in accordance with an exemplary embodiment. As illustrated in FIG. 5, the process flow 500 begins with receiving, by an error log processing device (ELPD) 504, a plurality of logs generated during a runtime of at least one application 508. The ELPD 504 is configured to analyze the plurality of logs to determine occurrence of at least one error log in the plurality of logs based upon predefined criteria and store the determined at least one error log based on the analysis of the plurality of logs, into at least one error log storage module 506. The at least one error log storage module 506 includes an error log table, at least one database and at least one topic.

Further, the ELPD 504 is configured to replay the at least one error log in accordance with predefined execution criteria to execute the at least one error log from a point of failure of the corresponding at least one error log in the at least one application 508. Finally, the ELPD 504 removes the replayed at least one error log upon successful execution of the at least one error log in the at least one application 508, from the at least one topic. In one example, ELPD 504 may remove the replayed at least one error log from the at least one topic instantly. However, the ELPD may keep such executed error logs for a predefined period in the error log table for audit/analytics purposes. Thereafter, the ELPD may remove these error logs from the error log table after passing the predefined period.

For example, when a record fails for execution under the scope of annotated method in the at least one application 508 or the data processing service, the ELPD 504 starts execution using a spring aspect to determine error logs via an error record generator 510 and stores the determined error logs into a topic (e.g., Kafka topic), an error log table, and a database. The topic contains the same record of the determined error logs as in the database and is used to maintain a queue of error logs to be reprocessed or executed after certain intervals of time. Further, a Kafka consumer listens to the at least one topic containing the queue of error logs that is to be reprocessed or executed and publishes it back to the topic till a predefined replay interval is not met. When at least one error log is eligible for replay, the Kafka topic passes the at least one error log to the ELPD 504 which executes the at least one error log using a replay scheduler 512 within the at least one application 508 to execute all the tasks required during reprocessing. The replay scheduler 512 is configured to schedule replay execution of the at least one error log for resolution of the at least one error log. Additionally, the ELPD 504 updates status of the at least one error log (for example, marked as processed in case of successful execution of the at least one error) in the database after the at least one error is reprocessed.

The ELPD 504 is configured to update a plurality of parameters for the replayed at least one error log in case of occurrence of failure caused to the replayed at least one error log. Further, the ELPD 504 causes to repeat the replay of the at least one failed error log in accordance to the predefined execution criteria in the at least one application 508.

If at least one user wants to manually process or execute the at least one error from the at least one database, then a replay request is required to be raised by the at least one user over a user interface (UI) of a platform (such as website or application). The platform may be connected with the at least one database. The platform is installed in a user device 502 is operated by the at least one user. The UI may be a graphical user interface (GUI). For example, the UI may be rendered on a display unit of the user device 502. In some examples, the user device 502 may include one of a tablet, a smartphone, a laptop, a desktop computer, a mainframe computer, a phablet, a smart watch, a personal digital assistant (PDA), and the like.

The at least one database may be connected with the ELPD 504. The ELPD 504 receives the replay request from the at least one user via the UI to access the error log table stored in the at least one database. Further, the ELPD 504 is configured to replay the at least one error log from the at least one database to execute the at least one error log from a point of failure of the corresponding at least one error log in the at least one application 508. If the at least one error log is successfully executed, then the ELPD 504 removes the replayed at least one error log from the at least one topic.

This way the ELPD 504 implements a method for processing error logs to provide a plug and play solution to resolve the error logs and provide self-healing to the at least one application 508 or data processing service.

It would be appreciated by the person skilled in the art that the ELPD 504 offers a full-circle, adaptable, and intelligent solution for implementing a method for processing error logs.

The present disclosure provides numerous advantages as given below. The present disclosure provides a plug and play solution that capable of processing error logs into data processing applications or systems. The present disclosure successfully resolves error logs without requiring any massive code changes in the data service applications or systems. The present disclosure enables the separation of concerns within data processing applications (or services) and provides flexibility to control the urgency of replay of error logs. The solution provided by the present disclosure can be integrated across the data processing applications or services with a distributed tech stack with different databases as well as with monolithic applications.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions for processing error logs is disclosed. The instructions include executable code which, when executed by a processor 104, may cause the processor 104 to receive, via a communication interface, a plurality of logs generated through a runtime of at least one application; analyze the plurality of logs to determine occurrence of at least one error log in the plurality of logs based upon predefined criteria; store the determined at least one error log based on the analysis of the plurality of logs, into an error log table, at least one database and at least one topic; replay the at least one error log in accordance with predefined execution criteria. The replay of the at least one error log is performed to execute the at least one error log from a point of failure of the corresponding at least one error log in the at least one application; and remove the replayed at least one error log upon successful execution of the at least one error log in the at least one application, from the at least one topic.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for processing error logs, the method being implemented by at least one processor, the method comprising:
receiving, by the at least one processor, a plurality of logs generated during a runtime of at least one application;
analyzing, by the at least one processor, the plurality of logs to determine an occurrence of at least one error log in the plurality of logs based upon predefined criteria;
storing, by the at least one processor, the at least one error log based on the analysis of the plurality of logs, into an error log table, at least one database and at least one topic;
replaying, by the at least one processor, the at least one error log in accordance with predefined execution criteria, wherein the replay of the at least one error log is performed to execute the at least one error log from a point of failure of the corresponding at least one error log in the at least one application; and
removing, by the at least one processor, the replayed at least one error log upon a successful execution of the at least one error log in the at least one application, from the at least one topic.

2. The method as claimed in claim 1, further comprising marking, by the at least one processor, the at least one error log as processed in the at least one database upon the successful execution of the replayed at least one error log.

3. The method as claimed in claim 1, wherein upon a failure of execution of the at least one error log, the method further comprises:
updating, by the at least one processor, a plurality of parameters for the replayed at least one error log in case of an occurrence of a failure caused to the replayed at least one error log, wherein the plurality of parameters comprises a retry count and a retry interval for the failed at least one error log; and
repeating, by the at least one processor, the replay of the at least one failed error log according to the predefined execution criteria in the at least one application after updating the plurality of parameters for the replayed at least one error log.

4. The method as claimed in claim 1, wherein the plurality of logs comprises a set of data associated with a plurality of records and events generated during the runtime of the at least one application.

5. The method as claimed in claim 1, wherein the error log table comprises an error date, a service text, an error type, a record identification, a send timestamp, an error message, a payload, a retry count, a retry status, a source, and a primary key.

6. The method as claimed in claim 1, wherein the predefined criteria correspond to validating that a type of parameter corresponds to a source record, checking a presence of the at least one error log in a list of exception classes, and checking whether the at least one error log falls in the list of the exception classes for which error logging has to be skipped.

7. The method as claimed in claim 1, wherein the at least one topic comprises error messages generated by the at least one error log.

8. The method as claimed in claim 1, wherein the predefined execution criteria comprise a threshold number of retries and a configured retry interval for the at least one error log.

9. The method as claimed in claim 1, further comprising receiving, by the at least one processor, a replay request from at least one user to perform a manual replay of the at least one error log stored in the at least one database.

10. A computing device configured to process error logs, the computing device comprising:
a processor;
a memory; and
a communication interface coupled to each of the processor and the memory, wherein the processor is configured to:
receive a plurality of logs generated through a runtime of at least one application;
analyze the plurality of logs to determine an occurrence of at least one error log in the plurality of logs based upon predefined criteria;
store the at least one error log based on the analysis of the plurality of logs, into an error log table, at least one database and at least one topic;
replay the at least one error log in accordance with predefined execution criteria, wherein the replay of the at least one error log is performed to execute the at least one error log from a point of failure of the corresponding at least one error log in the at least one application; and
remove the replayed at least one error log upon a successful execution of the at least one error log in the at least one application, from the at least one topic.

11. The computing device as claimed in claim 10, wherein the processor is further configured to mark the at least one error log as processed in the at least one database upon the successful execution of the replayed at least one error log.

12. The computing device as claimed in claim 10, wherein the processor is further configured to:
update a plurality of parameters for the replayed at least one error log in case of an occurrence of a failure caused to the replayed at least one error log, wherein the plurality of parameters comprises a retry count and a retry interval for the failed at least one error log; and
repeat the replay of the at least one failed error log in accordance with the predefined execution criteria in the at least one application after updating the plurality of parameters for the replayed at least one error log.

13. The computing device as claimed in claim 10, wherein the plurality of logs comprises a set of data associated with a plurality of records and events generated during the runtime of the at least one application.

14. The computing device as claimed in claim 10, wherein the error log table comprises an error date, a service text, an error type, a record identification, a send timestamp, an error message, a payload, a retry count, a retry status, a source, and a primary key.

15. The computing device as claimed in claim 10, wherein the predefined criteria correspond to validating that a type of parameter corresponds to a source record, checking a presence of the at least one error log in a list of exception classes, and checking whether the at least one error log falls in the list of the exception classes for which error logging has to be skipped.

16. The computing device as claimed in claim 10, wherein the at least one topic comprises error messages generated by the at least one error log.

17. The computing device as claimed in claim 10, wherein the predefined execution criteria comprise a threshold number of retries and a configured retry interval for the at least one error log.

18. The computing device as claimed in claim 10, wherein the processor is further configured to replay the at least one error log stored in the at least one database upon reception of a replay request from at least one user.

19. A non-transitory computer readable storage medium storing instructions for processing error logs, the storage medium comprising executable code which, when executed by a processor, causes the processor to:
receive a plurality of logs generated through a runtime of at least one application;
analyze the plurality of logs to determine an occurrence of at least one error log in the plurality of logs based upon predefined criteria;
store the determined at least one error log based on the analysis of the plurality of logs, into an error log table, at least one database and at least one topic;
replay the at least one error log in accordance with predefined execution criteria, wherein the replay of the at least one error log is performed to execute the at least one error log from a point of failure of the corresponding at least one error log in the at least one application; and
remove the replayed at least one error log upon a successful execution of the at least one error log in the at least one application, from the at least one topic.

20. The storage medium as claimed in claim 19, wherein when executed by the processor, the executable code further causes the processor to:
update a plurality of parameters for the replayed at least one error log in case of an occurrence of a failure caused to the replayed at least one error log, wherein the plurality of parameters comprises a retry count and a retry interval for the failed at least one error log; and
repeat the replay of the at least one failed error log in accordance with the predefined execution criteria in the at least one application after updating the plurality of parameters for the replayed at least one error log.
